(19) United States
(12) Patent Application Publication
(10) Pub. No.: US 2005/0110760 A1
(43) Pub. Date: May 26, 2005

(54) Computer mouse

(76) Inventors: Hsun-Li Huang, Hsinchu City (TW); Chun-Hsiung Yin, Tainan (TW)

Correspondence Address: RABIN & Berdo, PC, 1101 14TH STREET, NW, SUITE 500, WASHINGTON, DC, 20005, US

(21) Appl. No.: 10/990,402

(22) Filed: Nov. 18, 2004

(30) Foreign Application Priority Data
Nov. 21, 2003 (TW) 92132842
Feb. 20, 2004 (TW) 93104380

(51) Int. Cl. G09G 5/00; G09G 5/08

(52) U.S. Cl. 345/163

(57) ABSTRACT

A computer mouse including a mouse body and an extension part is disclosed. The extension part has a cavity for accommodating the mouse body. The extension part is a self-inflating air cushion having a gasbag and a valve. When the extension part is pressed, the air is exhausted from the gasbag through the valve so that the volume of the computer mouse is reduced as a compact form. Also, when the extension part is not pressed, the extension part inflates itself so that the gasbag is full of air through the valve.

This application claims the benefit of Taiwan applications Serial No. 92132842, filed Nov. 21, 2003 and Taiwan application Serial No. 93104380, filed Feb. 20, 2004, the subject matter of which are incorporated herein by reference.

### BACKGROUND OF THE INVENTION

1. Field of the Invention

The invention relates in general to a computer mouse for computers, and more particularly to a computer mouse having an extension part.

2. Description of the Related Art

A computer mouse, one pointing device for computers, effects the corresponding movement of a pointer or a cursor on the display of a computer to which the mouse is connected. Computer mice mainly include mechanical computer mice and optical computer mice. The mechanical computer mouse has a trackball, rollers or wheels protruding from the bottom surface of the mouse that enables the mouse to be rolled about to control the corresponding movement of a pointer or a cursor on the display of a computer. Compared with the mechanical computer mouse, the optical computer mouse controls the movement of the pointer or the cursor on the display of the computer by a detecting image movement technology and also the optical computer mouse is composed of various components, such as a sensor unit, an light emitting diode (LED), an optical lens, a sense IC, and so on.

FIG. 1A is a top plane view of a conventional optical computer mouse, and FIG. 1B is a lateral view of the conventional optical computer mouse in FIG. 1A. Referring both to FIG. 1A and FIG. 1B, an optical computer mouse 100 has a bottom surface 110 and a clicking part 160. The bottom surface 110 contacts with a plane 10 which enable the optical computer mouse 100 to be slid on the plane 10. Simultaneously, the clicking part 160 is operated by a user's fingers so as to control the corresponding movement of a pointer or a cursor on the display of a computer to which the mouse is connected.

With the advanced development of 3C (consuming electronics product, computer and communication) industries, the current manufactures tend to build a computer mouse with smaller size and lighter weight so that the computer mouse may be carried with ease. However, it is inconvenient for users in holding a small size computer mouse.

### SUMMARY OF THE INVENTION

In view of the foregoing, it is an object of the present invention to provide a computer mouse having an extension part. The extension part accommodates the computer mouse so as to enlarge a contact surface between the computer mouse and a user's hand and support the pressure that the user gives when the user uses the computer mouse.

The invention achieves the above-identified object by providing a computer mouse that includes an extension part and a mouse body. The extension part has a circular cavity, and the mouse body is accommodated in the extension part so as to enlarge a contact surface between the computer mouse and a user's hand when the user uses the computer mouse.

It is another object of the invention to provide a computer mouse that includes a mouse body and a self-inflating extension part. The mouse body has a clicking part, and the self-inflating extension part has a gasbag and a cavity for accommodating the mouse body detachably. The cavity has a side wall contacting with a side surface of the mouse body and the clicking part is exposed out of the cavity when the mouse body is accommodated in the cavity of the self-inflating extension part. The self-inflating extension part inflates and the gasbag is full of air through the valve when the self-inflating extension part is not pressed so as to enlarge a contact surface between the computer mouse and a user's hand.

It is another object of the invention to provide a computer mouse that includes a mouse body and an extension part. The mouse body has a clicking part, and the extension part has a circular cavity which has a upward opening. The clicking part of the main body is exposed out of the upward opening of the circular cavity, when the mouse body is accommodated in the circular cavity of the extension part, so that the extension part contacts with a user's hand and the clicking part is operated by the user's fingers simultaneously.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a top plane view of a conventional optical computer mouse.

FIG. 1B (Prior Art) is a lateral view of the conventional optical computer mouse in FIG. 1A.

FIG. 2A is a top plane view of a computer mouse according to the first example in the preferred embodiment of the present invention;

FIG. 2B is a lateral view of the computer mouse in FIG. 2A.

FIG. 2C is a schematic diagram showing the mouse body and the extension part of FIG. 2A.

FIG. 2D is an upward view of the computer mouse in FIG. 2A.

FIG. 3A is a lateral view of a computer mouse according to the second example in the preferred embodiment of the present invention.

FIG. 3B is a schematic diagram showing the mouse body and the extension part of FIG. 3A.

FIG. 3C is an upward view of the computer mouse in FIG. 3A.

FIG. 3D is a schematic diagram showing another computer mouse according to the second example in the preferred embodiment of the present invention of the present invention.

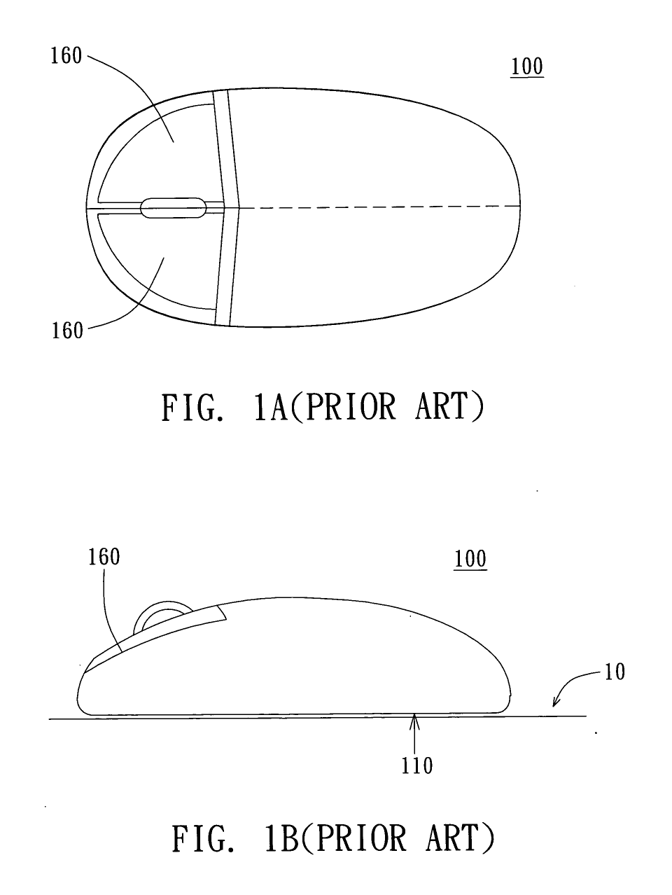

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like components throughout.

### First Embodiment

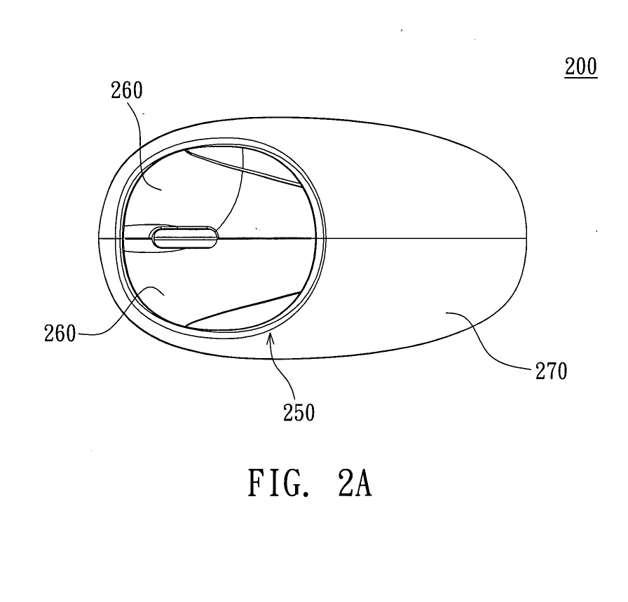

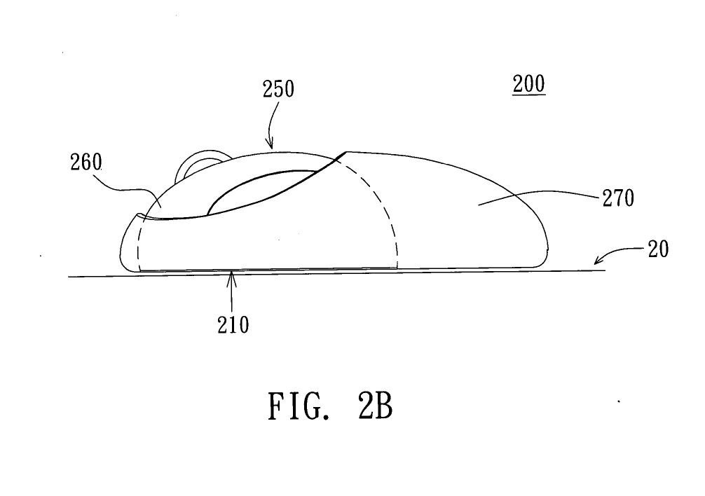

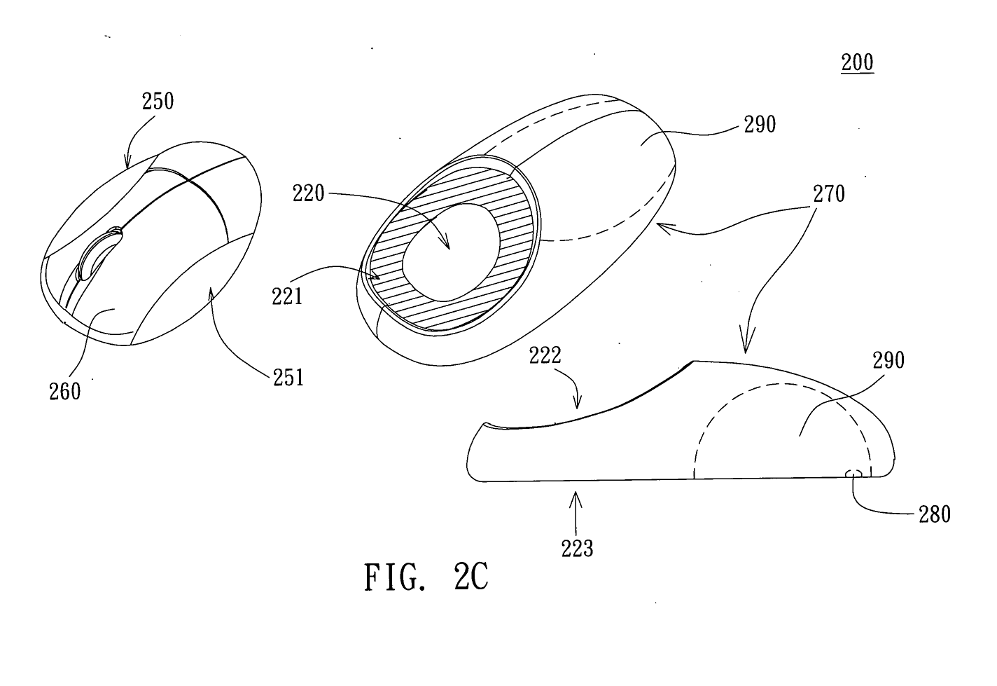

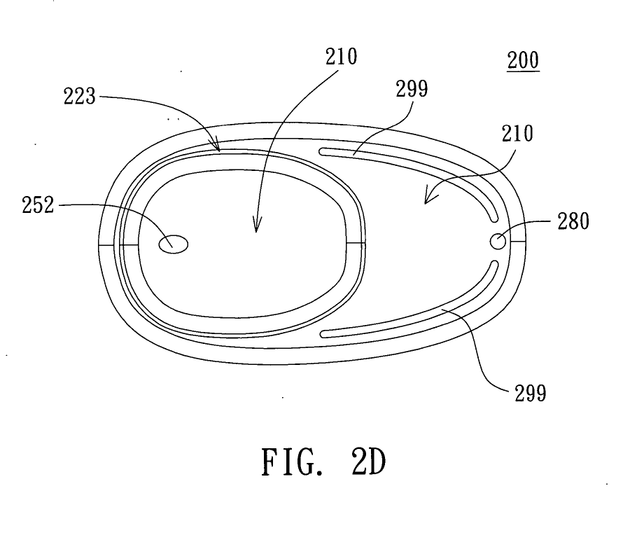

FIG. 2A is a top plane view of a computer mouse according to the first preferred embodiment of the present invention, and FIG. 2B is a lateral view of the computer mouse in FIG. 2A. Referring both to FIG. 2A and FIG. 2B, a computer mouse 200 mainly includes a mouse body 250 and an extension part 270. The extension part 270 has a cavity 220, preferably a circular cavity, as shown in FIG. 2C, which is a schematic diagram showing the mouse body and the extension part of FIG. 2A. In FIG. 2C, the mouse body is accommodated detachably in the circular cavity 220 of the extension part 270. When a user uses the computer mouse 200, the bottom surface 210 of the mouse body 250 contacts with a plane 20, and the extension part 270 is able to enlarge the contact surface between the computer mouse 200 and a user's hand.

Besides, referring to FIG. 2D, it is an upward view of the computer mouse in FIG. 2A. In FIG. 2D, the mouse body 250 itself is able to provide all functions that a computer mouse does without combining with the extension part 270. Further, the mouse body has a clicking part 260. User operates the clicking part 260 his fingers so as to effect a corresponding movement of a pointer or a cursor on the display of a computer.

The cavity 220 of the extension part 270 is a through hole that has an upward opening 222 and a downward opening 223. The cavity 220 also has a side wall 221. When the mouse body 250 is accommodated in the circular cavity 220 of the extension part 270, the side wall 221 preferably contacts with a side surface 251 of the mouse body 250, the clicking part 260 is preferably exposed out of the upward opening 222, and the bottom surface 210 of the mouse body 250 is preferably exposed out of the downward opening 223.

Moreover, the computer mouse disclosed in the first embodiment is suitable being an optical computer mouse without a cable, so that the mouse body 250 further includes an optical sensor 252, which is preferably equipped on the bottom surface 210 of the mouse body 250. When the mouse body 250 is accommodated in the cavity 220, the bottom surface 210 of the mouse body 250 is exposed out of the downward opening 223, and the optical sensor 252 is also exposed out of the downward opening 223 of the cavity 220.

### Second Embodiment

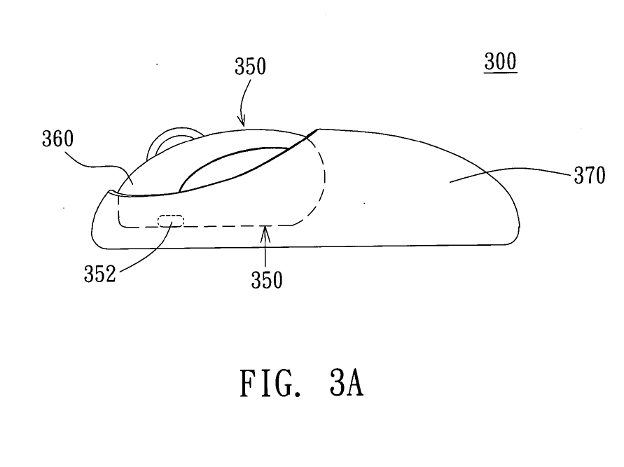

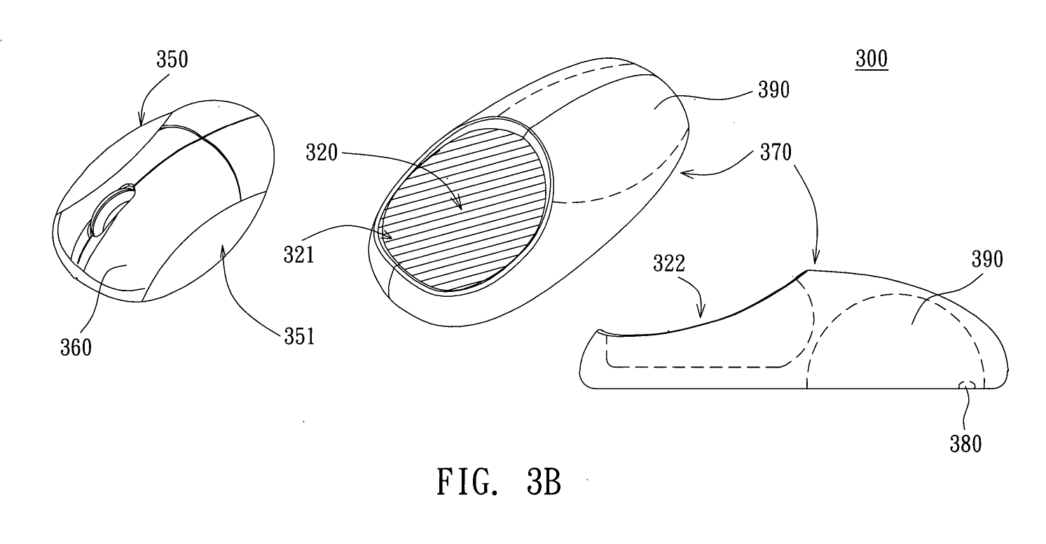

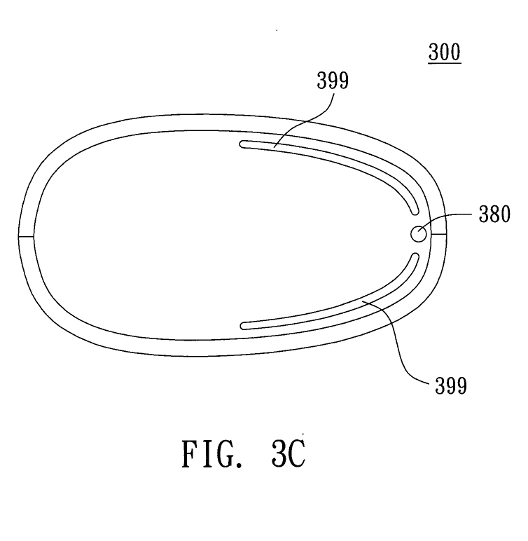

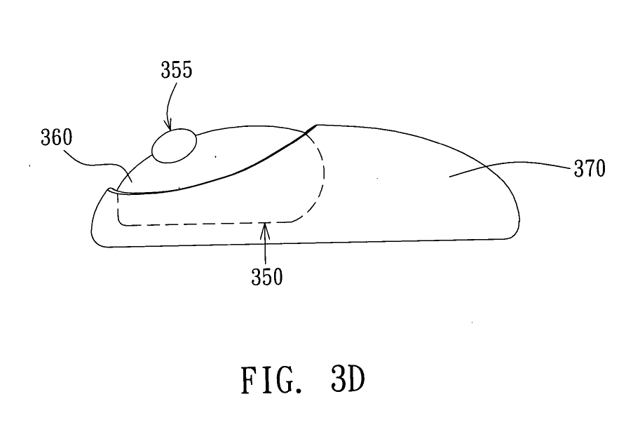

Referring to FIG. 3A, FIG. 3B, and FIG. 3C, FIG. 3A is a lateral view of a computer mouse according to the second preferred embodiment of the present invention, FIG. 3B is a schematic diagram showing the mouse body and the extension part of FIG. 3A, and FIG. 3C is an upward view of the computer mouse in FIG. 3A. Similarly to the computer mouse 200 of the first embodiment, a computer mouse 300 of the second embodiment mainly includes a mouse body 350 and an extension part 370. The mouse body 350 itself is able to provide all functions that a computer mouse does without combining with the extension part 370. The mouse body has a clicking part 360 that is operated by a user's fingers so as to effect a corresponding movement of a pointer or a cursor on the display of a computer to which the mouse is connected.

The extension part 370 has a cavity 320, preferably a circular cavity, and the mouse body 350 is detachably accommodated in the cavity 320 of the extension part 370. The extension part 27 is able to enlarge a contact surface between the computer mouse 300 and a user's hand when the user uses the computer mouse 300.

The difference of the second embodiment from the first embodiment is that the cavity 320 of the extension part 370 is not necessary to be a through hole that has an upward opening and a downward opening simultaneously. That is to say, the cavity 320 of the extension part 370 has only an upward opening 322 and a side wall 321. When the mouse body 350 is accommodated in the circular cavity 320 of the extension part 370, the side wall 321 preferably contacts with a side surface 351 of the mouse body 350, the clicking part 360 is preferably exposed out of the upward opening 322, and the bottom surface 310 of the mouse body 350 is not necessary to expose out of the circular cavity 320 of the extension part 370.

Beside, the computer mouse 300 of the second embodiment is applicable to various computer mice, for example, referring to FIG. 3D, it is a schematic diagram showing another computer mouse according to the second embodiment. In FIG. 3D, the computer mouse is preferably a mechanical computer mouse with small size that includes a mouse body 350 and an extension part 370. There are a trackball 355 and a clicking part 360 disposed on the same surface of the mouse body 350 to allow a user to operate the trackball 355 and the clicking part 360 with one hand, and to enlarge a contact surface between the computer mouse and the user's hand by using the extension part 370. Moreover, the computer mouse of the second embodiment is applicable to an optical computer mouse as long as the optical sensor of the optical computer mouse being able to be operated in the extension part 370.

The extension parts disclosed in the present invention, such as the extension part 270 of the first embodiment and the extension part 370 of the second embodiment, are used for accommodating a computer mouse. Referring both to FIG. 2C and FIG. 3B, the extension part 270/370 include a valve 280/380 and a gasbag 290/390, respectively. The valve 280/380 is preferably disposed in the rear end of the computer mouse 200/300 and the air can be flow in or flow out of the gasbag 290/390 through the valve 280/380. The air is exhausted from the gasbag 290/390 through the valve 280/380 when the extension part 270/370 is pressed, so that the volume of the computer mouse 200/300 is reduced as a compact form. Also, when the extension part 270/370 is not pressed, the extension part 270/370 inflates itself, so that the gasbag 290/390 is full of air through the valve 280/380. When the valve 280/380 is closed, the air cannot flow in or out the gasbag 290/390, so that the shape of the extension part 270/370 keeps unchanged. The extension part 270/370 is a self-inflating air cushion, and the extension part 270/370 further includes a cavity 220/320 for accommodating the mouse body 250/350.

The material of the self-inflating air cushion is polyethylene (PE), poly vinyl chloride (PVC), or other material with elasticity. Therefore, the gasbag 290/390 can be pressed flat and the volume of the extension part 270/370 is reduced as a compact form so that it's more convenient to carry.

As a result, the extension part 270/370 accommodates the mouse body 250/350 so as to enlarge a contact surface between the computer mouse 200/300 and a user's hand when the mouse body 250/350 is contained in the cavity 220/320 of the extension part 270/370. Also, the extension part 270/370 supports the pressure that the user gives when the user uses the computer mouse 200/300. Therefore, it brings users more ease and comfort to use the computer mouse 200/300.

Next, referring both to FIG. 2D and FIG. 3C, a smooth sheet 299/399 with low friction coefficient is applied to the bottom surface 210/310 of the extension part 270/370 so as to reduce a friction between the extension part 270/370 and a plane when the user moves the extension part 270/370 thereon. Beside, different colors or materials are applicable to the computer mouse of the present invention. Users can change the extension part with different colors any time as they like.

As described hereinbefore, by employing the extension part 270, 370 according to the first embodiment and the second embodiment, the extension part 270/370 is suitable to be applied not only to the optical computer mouse, but also to a computer mouse connected with a cable. A hole is disposed in the extension part 270/370 allowing the cable of the mouse body 250.350 to penetrate through. The location of the hole is not limited in one particular site; the location is decided by users according to their requirements.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A computer mouse, comprising:
an extension part having a circular cavity; and
a mouse body, being accommodated in the extension part, wherein a contact surface between the computer mouse and a user's hand is enlarged when the computer mouse is used.

2. The computer mouse according to claim 1, wherein the mouse body comprises a clicking part, and the circular cavity has a side wall, and when the mouse body is accommodated in the circular cavity of the extension part, the side wall of the circular cavity contacts with a side surface of the mouse body and the clicking part is exposed out of the circular cavity.

3. The computer mouse according to claim 1, wherein the extension part is a self-inflating air cushion.

4. The computer mouse according to claim 3, wherein the self-inflating air cushion comprises a gasbag and a valve, and when the self-inflating air cushion is pressed, the air is exhausted from the gasbag through the valve and the volume of the computer mouse is reduced, and when the self-inflating air cushion is not pressed, the self-inflating air cushion inflates itself and the gasbag is full of air.

5. The computer mouse according to claim 3, wherein the material of the self-inflating air cushion is polyethylene (PE).

6. The computer mouse according to claim 3, wherein the material of the self-inflating air cushion is poly vinyl chloride (PVC).

7. The computer mouse according to claim 1, wherein the computer mouse is connected with a cable and the extension part has a hole for the cable to pass through.

8. The computer mouse according to claim 1, wherein the extension part comprises a gasbag and a valve, and when the valve is open, the gasbag communicates with the outside surroundings via the valve, and the shape of the extension part keeps unchanged when the valve is closed.

9. A computer mouse, comprising:
a mouse body, having a clicking part; and
a self-inflating extension part, having a gasbag and a cavity detachably accommodating the mouse body;
wherein the cavity has a side wall contacting with a side surface of the mouse body and the clicking part is exposed out of the cavity when the mouse body is accommodated in the cavity of the extension part, and
wherein when the mouse body is accommodated in the cavity, and the self-inflating extension part inflates, a contact surface between the computer mouse and a user's hand is enlarged.

10. The computer mouse according to claim 9, wherein the self-inflating extension part further comprises a valve, and when the valve is open, the gasbag communicates with the outside surroundings via the valve, and the shape of the self-inflating extension part keeps unchanged when the valve is closed.

11. The computer mouse according to claim 10, wherein the self-inflating extension part is a self-inflating air cushion.

12. The computer mouse according to claim 11, wherein when the self-inflating air cushion is pressed, the air is exhausted from the gasbag through the valve and the volume of the computer mouse is reduced, when the self-inflating air cushion is not pressed, the self-inflating air cushion inflates itself.

13. The computer mouse according to claim 9, wherein the cavity comprises a downward opening and the mouse body comprises a bottom surface which is exposed out of the downward opening of the cavity.

14. A computer mouse, comprising:
a mouse body having a clicking part; and
an extension part having a circular cavity having an upward opening;
wherein when the mouse body is accommodated in the circular cavity of the extension part, the clicking part of the main body is exposed out of the upward opening of the circular cavity, so that the extension part contacts with a user's hand and the user operates the clicking part by his finger simultaneously.

15. The computer mouse according to claim 14, wherein the extension part comprises a gasbag and a valve, and when the valve is open, the gasbag communicates with the outside surroundings via the valve, and when the valve is closed, the shape of the extension part keeps unchanged.

16. The computer mouse according to claim 14, wherein a smooth sheet with low friction coefficient is applied onto a bottom surface of the extension part so as to reduce friction between the extension part and a plane when the extension part moves thereon.

17. The computer mouse according to claim 14, wherein the extension part is a self-inflating air cushion.

18. The computer mouse according to claim 17, wherein the self-inflating air cushion comprises a gasbag and a valve, and when the self-inflating air cushion is pressed, the air is exhausted from the gasbag through the valve and the volume of the computer mouse is reduced, and when the self-inflating air cushion is not pressed, the self-inflating air cushion inflates and the gasbag is full of air.

19. The computer mouse according to claim 14, wherein the circular cavity of the extension part further comprises a downward opening, and the mouse body has a bottom surface which is exposed out of the downward opening of the circular cavity.

20. An extension part for detachably accommodating a computer mouse, comprising:
a cavity for containing the computer mouse; and
a gasbag adjacent to the cavity, when the gasbag being full of air, a contact surface between the extension part and a user's hand being enlarged.

21. The extension part according to claim 20, wherein the extension part further comprises a valve, and the gasbag communicates with the outside surroundings via the valve so that the gasbag is selectively full of air or pressed flat, and when the valve is closed, the shape of the extension part keeps unchanged.

22. The extension part according to claim 20, wherein the extension part is a self-inflating air cushion.

23. The extension part according to claim 22, wherein when the self-inflating air cushion is pressed, the air is exhausted from the gasbag through the valve and the volume of the computer mouse is reduced, and when the self-inflating air cushion is not pressed, the self-inflating air cushion inflates itself.
